(19) United States
(12) Patent Application Publication
(10) Pub. No.: US 2006/0020569 A1
(43) Pub. Date: Jan. 26, 2006

(54) Apparatus, system, and method for time-based library scheduling

(76) Inventors: Brian Gerard Goodman, Tucson, AZ (US); Leonard George Jesionowski, Tucson, AZ (US); Jennifer Carolin Somers, Tucson, AZ (US)

Correspondence Address: KUNZLER & ASSOCIATES, 8 EAST BROADWAY, SUITE 600, SALT LAKE CITY, UT, 84111, US

(21) Appl. No.: 10/897,164

(22) Filed: Jul. 22, 2004

(51) Int. Cl. G06F 17/30

(52) U.S. Cl. 707/1

(57) ABSTRACT

An apparatus, system and method for library scheduling include a time-based schedule for mapping a data storage device to a plurality of logical libraries. The data storage device is mapped to the plurality of logical libraries in response to the time-based schedule. The data storage device may be in communication with a host application.

### BACKGROUND OF THE INVENTION

1. Field of the Invention

This invention relates to automated data storage libraries, and more particularly, to sharing data storage devices between logical libraries via a time-based scheduler.

2. Description of the Related Art

Automated data storage libraries (“ADSL”) are known for providing cost effective storage and retrieval of large quantities of data. The data in automated data storage libraries is stored on data storage media that are, in turn, stored on storage shelves or the like inside the library in a fashion that renders the media, and its resident data, accessible for physical retrieval. Such media is commonly termed “removable media.” Data storage media may comprise any type of media on which data may be stored and which may serve as removable media, including but not limited to magnetic media such as magnetic tape or disks, optical media such as optical tape or disks, electronic media such as Programmable Read Only Memory (“PROM”), Electrically Erasable Programmable Read Only Memory (“EEPROM”), flash PROM, Magnetoresistive Random Access Memory (“MRAM”), Micro Electro-Mechanical Systems (“MEMS”) based storage, or other suitable media.

Typically, the data stored in automated data storage libraries is resident on data storage media that is contained within a cartridge and is referred to alternatively as a data storage media cartridge, data storage cartridge, data storage media, media, and cartridge. One example of a data storage media cartridge that is widely employed in automated data storage libraries for mass data storage is a magnetic tape cartridge.

In addition to data storage media, automated data storage libraries typically contain data storage devices or drives that store data to, and/or retrieve data from, the data storage media. As used herein, the terms data storage devices, data storage drives, and drives are all intended to refer to devices that read data from and/or write data to removable media. The transport of data storage media between data storage shelves and data storage drives is typically accomplished by one or more pickers or robot accessors (“Accessors”). Such Accessors have grippers for physically retrieving the selected data storage media from the storage shelves within the automated data storage library and transporting the data storage media to the data storage drives by moving in one or more directions.

It is a common practice to share the resources of the library between different host computers and different host applications. Sharing library resources may be accomplished with library sharing software running on the host computer. Library sharing may also be accomplished through library partitioning. Library partitioning refers to a concept where the library accessor is shared between different host applications and the storage slots and drives are divided among the different host applications. A library partition is often referred to as a logical library or virtual library. Partitioning may further include sharing of the data storage drives. For example, data storage devices may be shared between different logical libraries on a first-come-first-served basis.

Unfortunately, when sharing data storage devices on a first-come-first-served basis, a first host application can consume all of the data storage device resources. In addition, the first host application may consume the data storage device resources without fully or productively utilizing the resources. A second host application that also requires access to the resources may be unable to complete tasks in a timely manner for want of controlled method of sharing data storage devices between logical libraries.

Consequently, a need exists for a process, apparatus, and system that share library resources according to a time-based schedule. Beneficially, such a process, apparatus, and system would improve the access of all host applications to library resources.

### SUMMARY OF THE INVENTION

The present invention has been developed in response to the present state of the art, and in particular, in response to the problems and needs in the art that have not yet been fully solved by currently available library allocation systems. Accordingly, the present invention has been developed to provide a method, apparatus, and system for time-based library scheduling that overcome many or all of the above-discussed shortcomings in the art.

The apparatus for library scheduling is provided with a logic unit containing a plurality of modules configured to functionally execute the necessary steps of time-based library scheduling. These modules in the described embodiments include a device resource module and a schedule module. The device resource module maps a data storage device to a plurality of logical libraries. A logical library comprises data storage media such as a data storage media cartridge.

In one embodiment, the library provides access to the data storage device for the plurality of logical libraries, which may in turn be associated with different host applications. The device resource module maps the data storage device to the logical libraries by assigning the data storage device to the logical library. The device resource module may map the data storage device to the logical library by logically associating the data storage device to the logical library. In one embodiment, the device resource module directs the mounting of the data storage media to the data storage device in, for example, an automated data storage library.

The schedule module schedules the data storage device to map to the logical libraries at one or more specified times according to a time-based schedule. For example, the schedule module may schedule the data storage device to map to a first logical library during a first time interval and to map to a second logical library during a second time interval. The apparatus allows host applications to access data storage devices with improved determinism.

A system of the present invention is also presented for library scheduling. The system may be embodied in a data storage system such as an automated data storage library. In particular, the system, in one embodiment, includes a plurality of logical libraries, a data storage device, and a resource manager. In one embodiment, the system also includes an Accessor.

The resource manager maintains a time-based schedule mapping a data storage device to at least one logical library. For example, the resource manager may maintain a schedule assigning a data storage device to a first logical library during a first time interval and assigning the data storage device to a second logical library during a second time interval. In addition, the resource manager maps the data storage device to the first logical library during the first time interval and maps the data storage device to the second logical library during the second time interval. Herein, mapping, assigning, and associating a data storage device to a logical library refer to the same process.

A method of the present invention is also presented for library scheduling. The process in the disclosed embodiments substantially includes the steps necessary to carry out the functions presented above with respect to the operation of the described apparatus and system. In one embodiment, the process includes maintaining a time-based schedule and mapping a data storage device to at least one logical library of a plurality of logical libraries.

The method maintains a time-based schedule for mapping the data storage device to the plurality of logical libraries. In one embodiment, the method maintains a schedule for a plurality of data storage devices to map to the plurality of logical libraries. The method maps the data storage device to a specified logical library at a specified time interval. In a certain embodiment, the method mounts a data storage media on the data storage device. In one embodiment, the method also includes overriding the time-based schedule.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention maps a data storage device to plurality of logical libraries according to a time-based schedule. In addition, the present invention makes access to the logical libraries more orderly and deterministic. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a data storage library in accordance with the present invention;

FIG. 2 is a block diagram illustrating one embodiment of a library scheduling apparatus of the present invention;

FIG. 3 is a flow chart illustrating one embodiment of a library scheduling method of the present invention;

FIG. 4 is an isometric view illustrating one embodiment of an automated data storage library adaptable to implement embodiments of the present invention, with the view specifically depicting a library having a left hand service bay, multiple storage frames and a right hand service bay;

FIG. 5 is an isometric view illustrating one embodiment of an automated data storage library adaptable to implement embodiments of the present invention, with the view specifically depicting an exemplary basic configuration of the internal components of a library;

FIG. 6 is a block diagram illustrating one embodiment of an automated data storage library adaptable to implement embodiments of the present invention, with the diagram specifically depicting a library that employs a distributed system of modules with a plurality of processor nodes;

FIG. 7 is a block diagram depicting one embodiment of an exemplary controller configuration in accordance with the present invention;

FIG. 8 is an isometric view of the front and rear of one embodiment of a data storage drive adaptable to implement embodiments of the present invention; and

FIG. 9 is a block diagram illustrating one embodiment of a host device in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices and processors. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

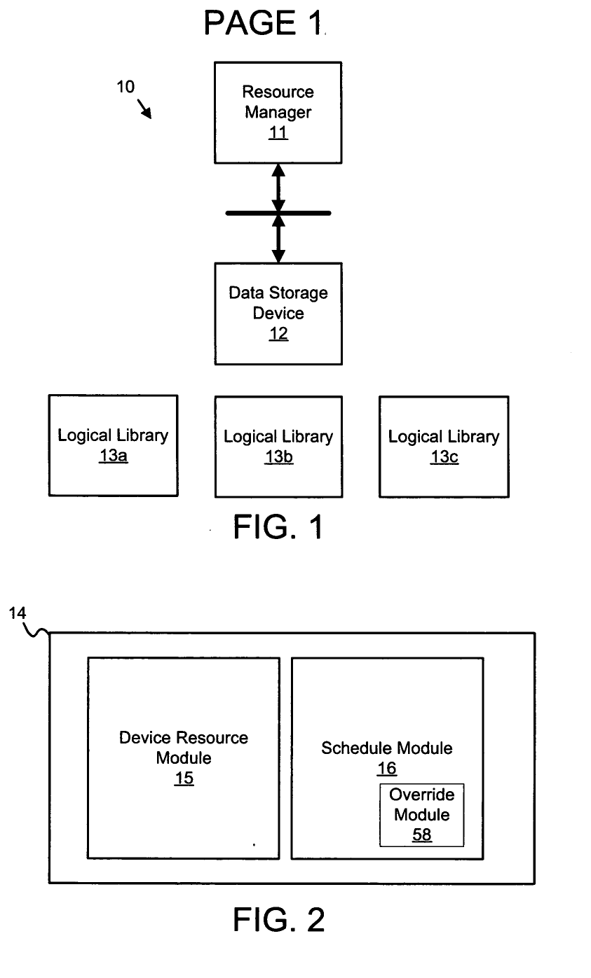

Turning now to the Figures, FIG. 1 illustrates a data storage library 10 that includes a resource manager 11, a data storage device 12, and a plurality of logical libraries 13. The logical libraries 13 comprise partitions or segments of an overall library wherein certain resources, such as a library Accessor, are shared between the logical libraries and wherein certain resources, such as data storage media, are not shared between the logical libraries. In addition, each logical library may be associated with a different host application. Data storage media includes but is not limited to magnetic tape, magnetic disks, optical tape, optical disks, semiconductor devices, Micro ElectroMechanical Systems (“MEMS”), and other suitable media. The logical libraries 13 are accessed by one or more host applications. Host applications may execute on one or more host systems.

The resource manager 11 maintains a time-based schedule mapping the data storage device 12 to at least one of the plurality of logical libraries 13 during one or more specified time intervals. Mapping as used herein refers to the library allowing media movement between the logical library 13 and the data storage device 12. Herein, mapping, assigning, and associating the data storage device 12 to the logical library 13 refer to the same process. For example, the resource manager 11 may maintain a schedule assigning the data storage device 12 to the first logical library 13a during a first time interval and assigning the data storage device 12 to the second logical library 13b during a second time interval. In addition, the resource manager 11 maps the data storage device 12 to the first logical library 13a during the first time interval and maps the data storage device 12 to the second logical library 13b during the second time interval. The resource manager 11 similarly maps the data storage device 12 to the third logical library 13c during a third time interval and so forth for additional time intervals.

The data storage library 10 makes access to the logical libraries 13 deterministic by mapping the data storage device 12 to the logical libraries 13 according to a time-based schedule. The data storage library 10 may prevent a first host application from excessively accessing a data storage device 12 to the detriment of a second host application needing to access that same data storage device 12. In one embodiment, the data storage library 10 maps the data storage device 12 to one or more host applications in response to a time-based host schedule. The time-based host schedule may be included in the time-based schedule.

FIG. 2 illustrates one embodiment of a library scheduling apparatus 14 that includes a device resource module 15 and a schedule module 16. The library scheduling apparatus 14 may be included in the resource manager 11 of FIG. 1. The device resource module 15 maps a data storage device 12 to a plurality of logical libraries 13. The device resource module 15 maps the data storage device 12 to the logical libraries 13 by assigning the data storage device 12 to one or more logical libraries 13. In one embodiment, the device resource module 15 directs the mounting of the data storage media to the data storage device

The schedule module 16 schedules the data storage device 12 to map to a logical library 13 at one or more specified time intervals according to a time-based schedule. For example, the schedule module 16 may schedule the data storage device 12 to map to the first logical library 13a during a first time interval, map to the second logical library 13b during a second time interval, and map the third logical library 13c to a third time interval. The library scheduling apparatus 14 allows deterministic access to data storage device 12 according to a time-based schedule.

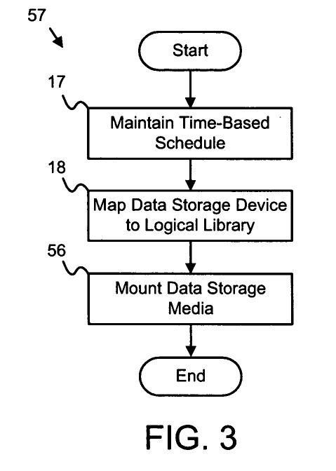

FIG. 3 is a flow chart illustrating one embodiment of a library scheduling method 57 of the present invention. Although for purposes of clarity the library scheduling method 57 is depicted in a certain sequential order, execution may be conducted in parallel and not necessarily in the depicted order.

The library scheduling method 57 maintains 17 a time-based schedule for mapping a data storage device 12 to a plurality of logical libraries 13. In one embodiment, the library scheduling method 57 maintains 17 a schedule for mapping a plurality of data storage devices 12 to the plurality of logical libraries 13. The library scheduling method 57 maps 18 the data storage device 12 to a specified logical library 13 at a specified time interval. In one embodiment, the library scheduling method 57 mounts 56 data storage media associated with the logical library 13 on the data storage device 12. The library scheduling method 57 may mount 56 the data storage media using an Accessor. In a certain embodiment, the library scheduling method 57 overrides the time-based schedule. For example, but without limitation, the library may provide an override module 58 that in one embodiment is in the form of a user interface that allows an operator to schedule drive mapping. This same user interface may be configured to allow the drive mapping to be turned off, disabled, bypassed one time, etc.

The library scheduling method 57 may schedule a data storage device 12 to map to a logical library 13 at a specified time interval to support a regular operation such as a backup operation. Scheduling the logical library 13 may allow the regular operation to efficiently use the data storage device 12 resources and to complete in a timely manner. Alternatively, a data storage device 12 may be mapped to the logical library 13 one time, or as needed, to support an irregular operation such as an on-demand operation. The on-demand operation may comprise a user-initiated operation involving the use of data storage media associated with a logical library 13. Alternatively, an on-demand operation may comprise a library, host, or remote computer initiated operation involving the use of data storage media associated with the logical library 13.

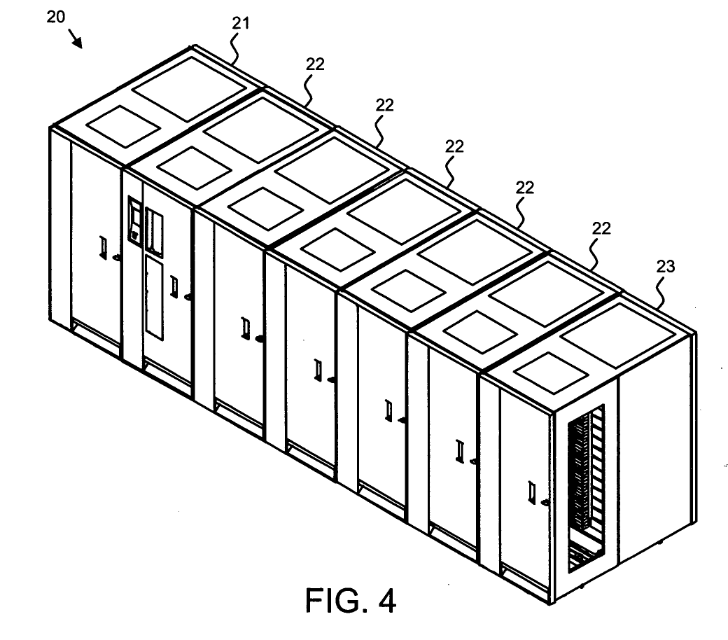

Turning now to FIGS. 4 through 8, the invention will be described as embodied in an automated magnetic tape storage library (“AMTSL”) 20 for use in a data processing environment. However, one skilled in the art will recognize the invention equally applies to optical disk cartridges or other removable storage media and the use of either different types of cartridges or cartridges of the same type having different characteristics. Furthermore the description of the AMTSL 20 is not meant to limit the invention to magnetic tape data processing applications as the invention herein can be applied to any media storage and cartridge handling systems in general. Herein, AMTSL, automated data storage library, ADSL, and library refer to a cartridge handling system for moving removable data storage media.

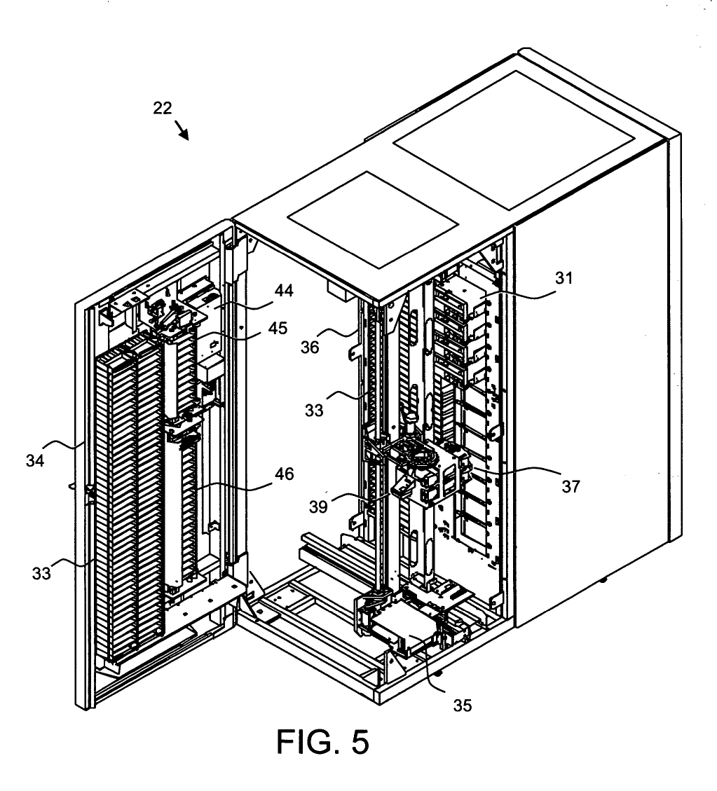

FIGS. 4 and 5 illustrates one embodiment of an AMTSL 20, which stores and retrieves data storage cartridges containing data storage media (not shown) in storage shelves 33. The AMTSL 20 may be the data storage library 10 of FIG. 1. It is noted that references to “data storage media” herein refer generally to both data storage cartridges and the media contained within, and for purposes herein the two terms are used interchangeably. An example of an AMTSL 20 that may implement the present invention, and has a configuration as depicted in FIGS. 4 and 5, is the IBM 3584 UltraScalable Tape Library™ manufactured by International Business Machines Corporation (“IBM”) of Armonk, New York. The AMTSL 20 of FIG. 4 comprises a left hand service bay 21, one or more storage frames 22, and right hand service bay 23. As will be discussed, a frame may comprise an expansion component of the AMTSL 20. Frames may be added or removed to expand or reduce the size and/or functionality of the AMTSL 20. Frames may include additional storage shelves, drives, import/export stations, Accessors, operator panels, etc.

FIG. 5 shows an example of a storage frame 22, which is the base frame of the AMTSL 20 and is contemplated to be the minimum configuration of the AMTSL 20. In this minimum configuration, there is only a single Accessor (i.e., there are no redundant Accessors) and there are no service bays. The AMTSL 20 is arranged for accessing data storage media in response to commands from at least one external host system (not shown), and comprises a plurality of storage shelves 33 on front wall 34 and rear wall 36 for storing data storage cartridges that contain data storage media; at least one data storage drive 31 for reading and writing data with respect to the data storage media; and a first Accessor 35 for transporting the data storage media between the plurality of storage shelves 33 and the data storage drive(s) 31. The data storage drive 31 may be a data storage device 12.

The data storage drives 31 may be optical disk drives, magnetic tape drives, and other types of data storage drives as are used to read and/or write data with respect to the data storage media. The storage frame 22 may optionally comprise a user interface 44 such as an operator panel or a web-based interface, which allows a user to interact with the library. The storage frame 22 may optionally comprise an upper I/O station 45 and/or a lower I/O station 46, which allows data storage media to be inserted into the library and/or removed from the library without disrupting library operation. The AMTSL 20 may comprise one or more storage frames 22, each having storage shelves 33 accessible by the first accessor 35.

As described above, the storage frames 22 may be configured with different components depending upon the intended function. One configuration of storage frame 22 may comprise storage shelves 33, data storage drive(s) 31, and other optional components to store and retrieve data from the data storage cartridges. The first Accessor 35 comprises a gripper assembly 37 for gripping one or more data storage media and may include a bar code scanner 39 or other reading system, such as a cartridge memory reader or similar system, mounted on the gripper 37 to “read” identifying information about the data storage media.

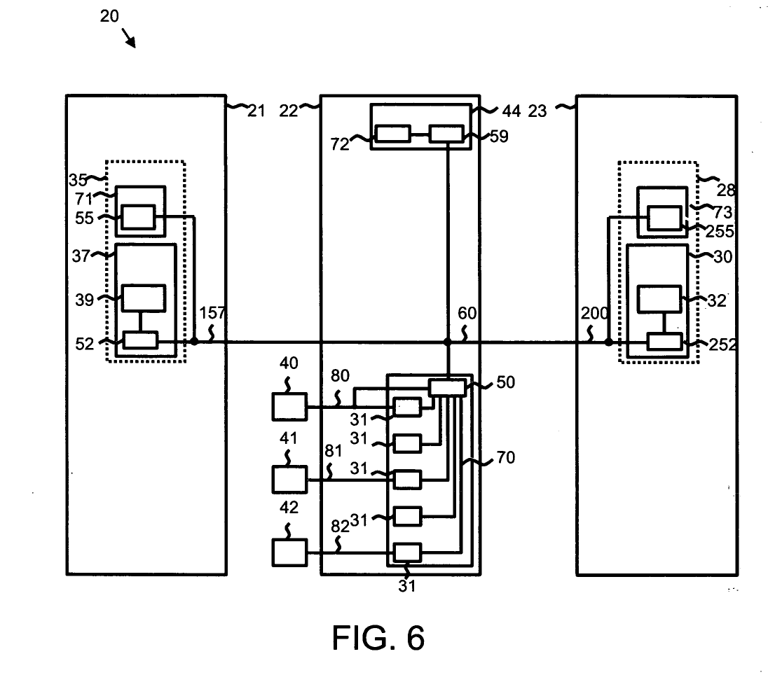

FIG. 6 illustrates an embodiment of the AMTSL 20 of FIGS. 4 and 5, which employs a distributed system of modules with a plurality of processor nodes. An example of an AMTSL 20 which may implement the distributed system depicted in the block diagram of FIG. 6, and which may implement the present invention, is the IBM 3584 UltraScalable Tape Library manufactured by IBM of Armonk, New York.

While the AMTSL 20 has been described as employing a distributed control system, the present invention may be implemented in AMTSLs regardless of control configuration, such as, but not limited to, an AMTSL having one or more library controllers that are not distributed. The library of FIG. 6 comprises one or more storage frames 22, a left hand service bay 21 and a right hand service bay 23. The left hand service bay 21 is shown with a first Accessor 35. As discussed above, the first Accessor 35 comprises a gripper assembly 37 and may include a reading system 39 to “read” identifying information about the data storage media. The right hand service bay 23 is shown with a second Accessor 28. The second Accessor 28 comprises a gripper assembly 30 and may include a reading system 32 to “read” identifying information about the data storage media.

In the event of a failure or other unavailability of the first Accessor 35, or its gripper 37, etc., the second Accessor 28 may perform some or all of the functions of the first Accessor 35. The Accessors 35, 28 may share one or more mechanical paths. In an alternate embodiment, the Accessors 35, 28 may comprise completely independent mechanical paths. In one example, the Accessors 35, 28 may have a common horizontal rail with independent vertical rails. The first Accessor 35 and the second Accessor 28 are described as first and second for descriptive purposes only and this description is not meant to limit either Accessor 35, 28 to an association with either the left hand service bay 21, or the right hand service bay 23. In addition, the AMTSL 20 may employ any number of Accessors 35, 28.

In the exemplary library, the first Accessor 35 and the second Accessor 28 move their grippers in at least two directions, called the horizontal “X” direction and vertical “Y” direction, to retrieve and grip, or to deliver and release the data storage media at the storage shelves 33 and to load and unload the data storage media at the data storage drives 31. The AMTSL 20 receives commands from one or more host systems 40, 41 and 42. The host systems 40, 41, and 42, such as host servers, may communicate with the AMTSL 20 directly, e.g., on a path 80 through one or more control ports (not shown). In an alternate embodiment, the host systems 40, 41, and 42 communicate with the AMTSL 20 through one or more data storage drives 31 on paths 81, 82, providing commands to access particular data storage media and move the media, for example, between the storage shelves 33 and the data storage drives 31. The commands are typically logical commands identifying the media and logical locations for accessing the data storage media. The terms “commands” and “work requests” are used interchangeably herein to refer to such communications from the host system 40, 41 and 42 to the AMTSL 20 as are intended to result in accessing particular data storage media within the AMTSL 20.

The AMTSL 20 is controlled by a distributed control system receiving the logical commands from host systems 40, 41 and 42, determining the required actions, and converting the actions to physical movements of first Accessor 35 and second Accessor 28. In the AMTSL 20, the distributed control system comprises a plurality of processor nodes, each having one or more processors. In one example of a distributed control system, a communication processor node 50 may be located in a storage frame 22. The communication processor node 50 provides a communication link for receiving the host commands, directly and/or through the drives 31, via at least one external interface, e.g., coupled to lines 80, 81, 82.

The communication processor node 50 may additionally provide one or more communication links 70 for communicating with the data storage drives 31. The communication processor node 50 may be located in the frame 22, close to the data storage drives 31. Additionally, in an example of a distributed processor system, one or more additional work processor nodes 52 are provided, which may comprise, e.g., a work processor node 52 that may be located at first Accessor 35, and that is coupled to the communication processor node 50 via a network 60, 157. Each work processor node 52 may respond to received commands that are broadcast to the work processor nodes from any communication processor node, and the work processor nodes 52 may also direct the operation of the Accessors 35, 28 by providing move commands.

An XY processor node 55 may be provided and may be located at an XY system of first Accessor 35. The XY processor node 55 is coupled to the network 60, 157, and is responsive to the move commands, operating the XY system to position the gripper 37. Also, an operator panel processor node 59 may be provided at the optional operator panel 44 for providing an interface for communicating between the user interface 44 and the communication processor node 50, the work processor nodes 52, 252, and the XY processor nodes 55, 255. The user interface 44 may include a display 72.

A network, for example comprising a common bus 60, is provided, coupling the various processor nodes. The network may comprise a robust wiring network, such as the commercially available Controller Area Network (“CAN”) bus system, which is a multi-drop network, having a standard access protocol and wiring standards, for example, as defined by the CAN in Automation Association (“CiA”) of Am Weich Selgarten 26, D-91058 Erlangen, Germany. Other networks, such as Ethernet, or a wireless network system, such as radio frequency or infrared, may be employed in the library as is known to those of skill in the art. In addition, multiple independent connections and/or networks may also be used to couple the various processor nodes.

The communication processor node 50 is coupled to each of the data storage drives 31 of a storage frame 22, via lines 70, communicating with the data storage drives 31 and with host systems 40, 41 and 42. Alternatively, the host systems 40, 41 and 42 may be directly coupled to the communication processor node 50, at input 80 for example, and to control port devices (not shown) which connect the library to the host system(s) 40, 41 and 42 with a library interface similar to the drive/library interface. As is known to those of skill in the art, various communication arrangements may be employed for communication with the hosts systems 40, 41 and 42 and with the data storage drives 31. In the example of FIG. 6, host connections 80 and 81 are Small Computer Systems Interface (“SCSI”) busses. Bus 82 comprises an example of a Fiber Channel bus, which is a high-speed serial data interface, allowing transmission over greater distances than the SCSI bus systems.

The data storage drives 31 may be in close proximity to the communication processor node 50, and may employ a short distance communication scheme, such as SCSI, or a serial connection, such as RS-422. The data storage drives 31 are thus individually coupled to the communication processor node 50 by means of lines 70. Alternatively, the data storage drives 31 may be coupled to the communication processor node 50 through one or more networks, such as a common bus network. Additional storage frames 22 may be provided and each may be coupled to the adjacent storage frame. Any of the storage frames 22 may comprise communication processor nodes 50, storage shelves 33, data storage drives 31, and networks 60.

Further, as described above, the AMTSL 20 may comprise a plurality of Accessors 35, 28. A second Accessor 28, for example, is shown in a right hand service bay 23 of FIG. 6. The second Accessor 28 may comprise a gripper 30 for accessing the data storage media, and an XY system 255 for moving the second Accessor 28. The second Accessor 28 may run on the same horizontal mechanical path as first Accessor 35, and alternatively on an adjacent path. The exemplary control system additionally comprises an extension network 200 forming a network coupled to network 60 of the storage frame(s) 22 and to the network 157 of left hand service bay 21.

In FIG. 6 and the accompanying description, the first Accessor 35 and the second Accessor 28 are associated with the left hand service bay 21 and the right hand service bay 23 respectively. This is for illustrative purposes and there may not be an actual association. In addition, the network 157 may not be associated with the left hand service bay 21 and network 200 may not be associated with the right hand service bay 23. Further, networks 157, 60 and 200 may comprise a single network or may comprise multiple independent networks. Depending on the design of the AMTSL 20, it may not be necessary to have a left hand service bay 21 and/or a right hand service bay 23.

The AMTSL 20 typically comprises one or more controllers to direct the operation of the AMTSL 20. Host computers and data storage drives 31 typically comprise similar controllers. A controller may take many different forms and may comprise, for example but not limited to, an embedded system, a distributed control system, a personal computer, or a workstation. Essentially, the term controller as used herein is intended in its broadest sense as a device that contains at least one processor, as such term is defined herein.

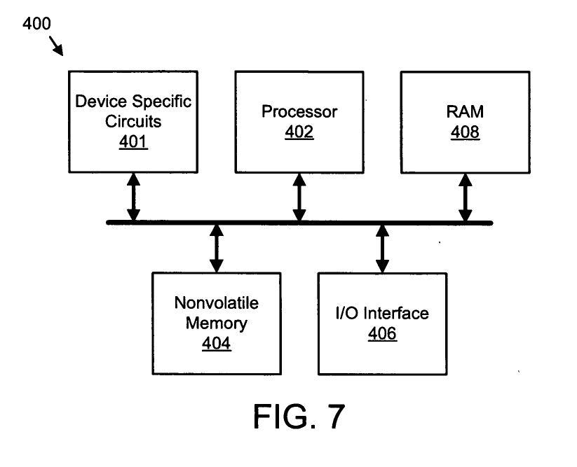

FIG. 7 shows a typical controller 400 with a processor 402, Random Access Memory (“RAM”) 408, nonvolatile memory 404, device specific circuits 401, and I/O interface 406. Alternatively, the RAM 408 and/or nonvolatile memory 404 may be contained in the processor 402 as could the device specific circuits 401 and I/O interface 406. The processor 402 may comprise, for example, an off-the-shelf microprocessor, custom processor, Field Programmable Gate Array (“FPGA”), Application Specific Integrated Circuit (“ASIC”), discrete logic, and similar modules. The RAM 408 is typically used to hold variable data, stack data, executable instructions, and the like.

The nonvolatile memory 404 may comprise any type of nonvolatile memory such as, but not limited to, Programmable Read Only Memory (“PROM”), Electrically Erasable Programmable Read Only Memory (“EEPROM”), flash PROM, Magnetoresistive Random Access Memory (“MRAM”), Micro Electro-Mechanical Systems (“MEMS”) based storage, battery backup RAM, and hard disk drives. The nonvolatile memory 404 is typically used to hold the executable firmware and any nonvolatile data. The I/O interface 406 comprises a communication interface that allows the processor 402 to communicate with devices external to the controller 400. Examples may comprise, but are not limited to, serial interfaces such as RS-232, Universal Serial Bus (“USB”) or SCSI.

The device specific circuits 401 provide additional hardware to enable the controller 400 to perform unique functions such as, but not limited to, motor control of a cartridge gripper. The device specific circuits 401 may comprise electronics that provide, by way of example but not limitation, Pulse Width Modulation (“PWM”) control, Analog to Digital Conversion (“ADC”), Digital to Analog Conversion (“DAC”), etc. In addition, all or part of the device specific circuits 401 may reside outside the controller 400.

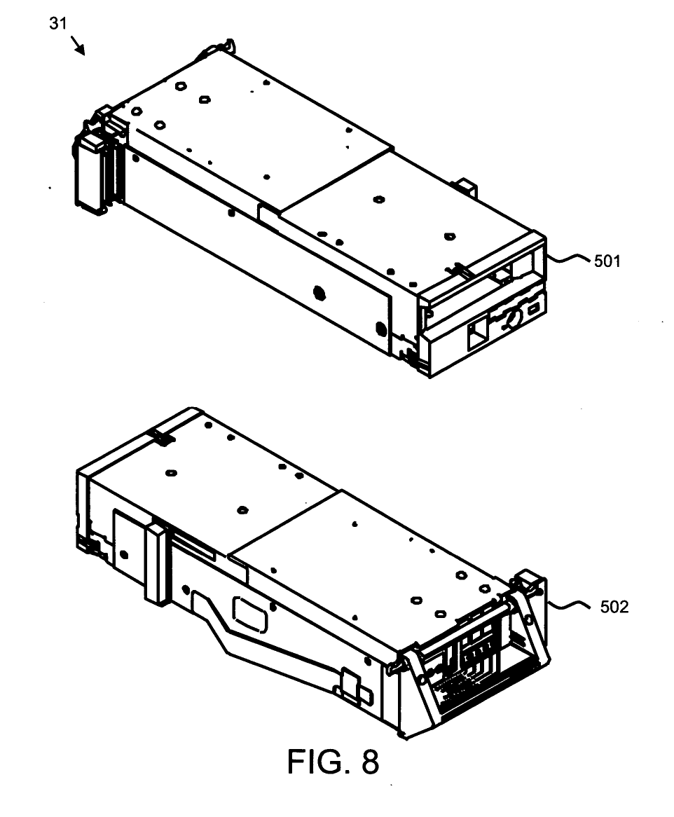

FIG. 8 illustrates an embodiment of the front 501 and rear 502 of a data storage device 31. In the example of FIG. 8, the data storage drive 31 comprises a hot-swap drive canister. The data storage device 31 is only an example and is not meant to limit the invention to hot-swap drive canisters. Any configuration of data storage devices 31 may be used whether or not it comprises a hot-swap canister.

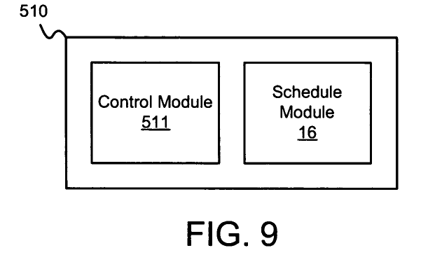

FIG. 9 is a block diagram illustrating one embodiment of a host device 510 in accordance with the present invention. The host device 510 typically controls the mounting of data storage media in a data storage device 12. The host device 510 may be a host system 40. In an alternate embodiment, the host device 510 may be a host application. The control module 511 sends commands to the ADSL for moving data storage media to/from data storage device(s) 12. The data storage device 12 provides access to the data stored on the data storage media. The schedule module 16 maintains a time-based schedule for operating and using the ADSL to read and/or write data to/from data storage media contained in the ADSL.

The present invention improves upon data storage device(s) 12 sharing by allowing the data storage device 12 resources to be shared according to time-based information. A library interface allows a user to assign particular data storage device(s) 12 to particular logical libraries 13 within a single physical library. The assignment allows date and/or time information to be associated with each data storage device 12 such that a particular data storage device 12 will be assigned or associated with a particular logical library 13 at a given date and/or time and/or time interval. The assignments set up by the user may be automated by the library such that a data storage device 12 assignment to different logical libraries 13 occurs automatically based on a schedule.

For example, a physical library may be partitioned into five logical libraries 13. The host applications for each logical library 13 may require six data storage devices 12 to perform the backup/restore operations in a reasonable amount of time. This would normally require thirty data storage devices 12 for the entire library. By coordinating each of the host application backups with the data storage device 12 sharing schedule of the library, six data storage devices 12 could be shared between the five different logical libraries 13 rather than mapping a unique set of six data storage devices 12 to each logical library 13. This may be accomplished by scheduling the five different host applications to perform their backups at different times and coordinating the data storage device 12 sharing schedule to share the data storage devices 12 with the appropriate host application at the appropriate times.

Coordinating of the host application schedule with the library sharing schedule may be loosely coupled. For example, there may be a gap in time between the mapping of a data storage device 12 to a logical library 13, and the actual use of that data storage device 12 by a host application of a host system 40. Because of this gap in time, the start and/or stop time of the library sharing schedule does not have to be precisely the same time as the start and/or stop time of the host schedule. By loosely coupling the coordination of the host schedule to the library sharing schedule, any clocks associated with the library are not required to be in tight synchronization with any clocks associated with the host. In addition, the loose coupling helps reduce any resource conflict that may arise as a result of a host application taking longer to complete all accesses to a data storage device 12. Longer than expected host access may be the result of error recovery procedures that lengthen access time, changes in communication speed, changes in expected compression levels of the data being read and/or written, etc.

The concept of loose coupling under the invention can be better understood with an example. In this example, a first host application is associated with a first logical library 13a and a second host application is associated with a second logical library 13b. In addition, a data storage device 12 is shared between the two logical libraries. The first host application may be set up to use the shared data storage device 12 from 12 AM to 2 AM each day, and the second host application may be set up to use the shared data storage device 12 from 4 AM to 5 AM each day. The library sharing schedule for the shared data storage device 12 may be set up to map the data storage device 12 to the first logical library from 11 PM to 3 AM and to map the data storage device 12 to the second logical library from 3 AM to 6 AM.

In this example, there is an hour of time variation between the data storage device 12 mapping and the host application use of that data storage device 12. In other words, the library schedule overlaps the host schedule by one hour. While this example describes a start and stop time for the schedules, it is not meant to limit the invention to start/stop schedules. In fact, the invention may use start times, stop times, start and stop times, start times and durations, stop times and durations, durations, etc. In addition, dates, days, times, hours, or any other unit of measure for time may also be used.

In one embodiment of the invention, data storage devices 12 are shared between logical libraries 13 via a schedule. A library interface allows a user to assign. particular drives to particular logical libraries within a single physical library. The assignment allows date and/or time and/or time interval information to be associated with each data storage device 12 such that a particular data storage device 12 may be assigned with a particular logical library 13 at a given date and/or time. The assignments set up by the user are automated by the library such that a data storage device 12 assignment or association to different logical libraries 13 occurs automatically based on a schedule.

The present invention maps a data storage device 12 to plurality of logical libraries 13 according to a time-based schedule. In addition, the present invention makes access to the logical libraries 13 more orderly and deterministic. Those skilled in the art will appreciate that the various aspects of the invention may be achieved through different embodiments without departing from the essential function of the invention. The particular embodiments are illustrative and not meant to limit the scope of the invention as set forth in the following claims. The present invention may be embodied in other specific forms without departing from its spirit or essential characteristics. The scope of the invention is, therefore, indicated by the appended claims rather than by the foregoing description. All changes which come within the meaning and range of equivalency of the claims are to be embraced within their scope.

What is claimed is:

1. A computer readable storage medium comprising computer readable code for conducting a method of library scheduling, the method comprising:
maintaining a time-based schedule for mapping a data storage device to a plurality of logical libraries; and
mapping the data storage device to at least one logical library responsive to the time-based schedule.

2. The computer readable storage medium of claim 1, the method further comprising mapping the data storage device to a first logical library during a first time interval and mapping the data storage device to a second logical library during a second time interval.

3. The computer readable storage medium of claim 1, the method further comprising mapping the data storage device to the at least one logical library to support a backup operation.

4. The computer readable storage medium of claim 1, the method further comprising overriding the time-based schedule.

5. The computer readable storage medium of claim 1, the method further comprising a host application accessing the data storage device based on a time-based host

6. The computer readable storage medium of claim 5, the method further comprising coordinating the time-based host schedule with the time-based schedule.

7. The computer readable storage medium of claim 1, wherein the data storage device mapping is controlled by a distributed control system.

8. The computer readable storage medium of claim 7, wherein the distributed control system comprises a plurality of processor nodes.

9. The computer readable storage medium of claim 1, wherein the method further comprising mapping a plurality of data storage devices to the plurality of logical libraries.

10. A method for library scheduling, the method comprising:
maintaining a time-based schedule for mapping a data storage device to a plurality of logical libraries; and
mapping the data storage device to at least one logical library responsive to the time-based schedule.

11. The method of claim 10, further comprising overriding the time-based schedule.

12. The method of claim 10, wherein mapping the data storage device comprises mapping the data storage device to the at least one logical library to support a backup operation.

13. The method of claim 10, further comprising mapping the data storage device to a first logical library during a first time interval and mapping the data storage device to a second logical library during a second time interval.

14. The method of claim 10, the method further comprising the host application accessing a data storage device based on a time-based host schedule and coordinating the time-based host schedule with the time-based schedule.

15. A library scheduling apparatus, the apparatus comprising:
a device resource module configured to map a data storage device to a plurality of logical libraries; and
a schedule module configured to schedule the data storage device to map to at least one logical library responsive to a time-based schedule.

16. The apparatus of claim 15, wherein the schedule module is configured to schedule the data storage device to map to a first logical library during a first time interval and schedule the data storage device to map to a second logical library during a second time interval.

17. The apparatus of claim 15, wherein the schedule module is configured to schedule the data storage device to map to the at least one logical library to support a backup operation.

18. The apparatus of claim 15, further comprising an overwrite module with which an operator may override the scheduling module.

19. The apparatus of claim 15, further comprising a host application running on a host computer, the host computer connected to the data storage device, the host application configured to access the data storage device based on a time-based host schedule and wherein the time-based host schedule is coordinated with the time-based schedule.

20. The apparatus of claim 15, wherein the data storage device mapping is controlled by a distributed control system.

21. A host library scheduling device, the device comprising:
a schedule module of a host system configured to maintain a time-based schedule mapping a data storage device to a plurality of logical libraries; and
a control module configured to map the data storage device to at least one logical library responsive to the time-based schedule.

22. A library scheduling system, the system comprising:
a plurality of logical libraries;
a data storage device; and
a resource manager configured to schedule the data storage device to map to at least one logical library and to map the data storage device to the at least one logical library responsive to a time-based schedule.

23. The system of claim 22, wherein the resource manager is configured to map the data storage device to a first logical library during a first time interval and map the data storage device to a second logical library during a second time interval.

24. The system of claim 22, wherein the resource manager is configured to map the data storage device to the at least one logical library to support a backup operation.

25. The system of claim 22, wherein a plurality of data storage devices are mapped to the plurality of logical libraries.

26. The system of claim 22, further comprising an override module with which an operator may override the mapping of the data storage device.

27. The system of claim 22, further comprising a host application running on a host system, the host system connected to the data storage device, wherein the host application accesses the data storage device based on a time-based host schedule.

28. The system of claim 27, wherein the time-based host schedule is coordinated with the time-based schedule.

29. The system of claim 22, wherein the data storage device mapping is controlled by a distributed control system.

30. A library scheduling apparatus, the apparatus comprising:
means for maintaining a time-based schedule for mapping a storage device to a plurality of logical libraries; and
means for mapping the data storage device to at least one logical library responsive to the time-based schedule.
